(19) United States
(12) Patent Application Publication
(10) Pub. No.: US 2025/0319542 A1
(43) Pub. Date: Oct. 16, 2025

(54) COOLANT LEVEL SENSING FOR TORCH SYSTEM

(71) Applicant: The ESAB Group, Inc., North Bethesda, MD (US)

(72) Inventors: Andrew John Raymond, Lebanon, NH (US); Secundino Miguel Baldonado, Hopkinton, NH (US)

(21) Appl. No.: 19/172,922

(22) Filed: Apr. 8, 2025

Related U.S. Application Data
(60) Provisional application No. 63/634,565, filed on Apr. 16, 2024.

(51) Int. Cl. B23K 10/00; B23K 37/003; G01F 23/22; G01K 3/00; G01K 13/02

(52) U.S. Cl. CPC B23K 10/006; B23K 37/003; G01F 23/22; G01K 3/005; G01K 13/026

(57) ABSTRACT

A torch system includes a torch configured to perform a welding or cutting operation, a reservoir configured to store coolant, a conduit system configured to circulate coolant between the reservoir and the torch to cool the torch, and a control system. The control system is configured to determine a temperature of coolant in the reservoir, the temperature of coolant in the reservoir indicating a level of coolant circulating between the reservoir and the torch, compare the temperature of coolant in the reservoir to a threshold temperature, and output a signal in response to determining the temperature of coolant in the reservoir exceeds the threshold temperature.

### CROSS-REFERENCE TO RELATED APPLICATION

This application claims priority to and the benefit of U.S. Provisional Patent Application No. 63/634,565, entitled “COOLANT LEVEL SENSING FOR TORCH SYSTEM,” filed Apr. 16, 2024, which is hereby incorporated by reference in its entirety for all purposes.

### TECHNICAL FIELD

The present disclosure is directed toward welding and/or cutting torches and, in particular, to methods of determining a level of coolant circulating between a torch and a reservoir.

### BACKGROUND

A torch, such as a cutting torch or a welding torch, is used to perform various operations with respect to a metal workpiece. For example, the torch may be used to remove material from the metal workpiece for a cutting operation or to melt material for a welding operation. In either case, the torch includes a torch body and at least one consumable component (e.g., in addition to consumable wire). A coolant (e.g., water) may be directed through the torch to reduce or limit a temperature increase of the torch to maintain desirable operation and/or structural integrity of the torch. For example, the coolant may be circulated between the torch and a reservoir configured to store the coolant. However, a level of coolant circulating between the torch and the reservoir may be or become low during operations. For instance, coolant may leak or otherwise exit out of its flow path and/or a flow of coolant may be hindered or blocked at a portion of its flow path. This may reduce a cooling capacity provided by the coolant.

### SUMMARY

The present disclosure is directed towards determining a level of cooling circulating between a reservoir and a torch. These techniques may be embodied as a torch system and/or a non-transitory computer-readable storage media.

In accordance with at least one embodiment, the present application is directed to a torch system that includes a torch configured to perform a welding or cutting operation, a reservoir configured to store coolant, a conduit system configured to circulate coolant between the reservoir and the torch to cool the torch, and a control system. The control system is configured to determine a temperature of coolant in the reservoir indicating a level of coolant circulating between the reservoir and the torch, compare the temperature of coolant in the reservoir to a threshold temperature, and output a signal in response to determining the temperature of coolant in the reservoir exceeds the threshold temperature.

In accordance with at least another embodiment, the present application is directed to a non-transitory computer-readable medium. The includes non-transitory computer-readable medium includes instructions that, when executed by one or more processors, are configured to cause the one or more processors to determine a temperature of coolant in a reservoir, the reservoir storing coolant that circulates through a torch configured to perform a welding or cutting operation, determine a level of coolant circulating between the reservoir and the torch based on the temperature of coolant in the reservoir, and output a signal based on the level of coolant in the reservoir.

In accordance with at least a further embodiment, the present application is directed to a torch system. The torch system includes a torch configured to perform a welding or cutting operation, a reservoir configured to store coolant, a heat exchanger configured to reduce a temperature of coolant in the reservoir, a conduit system configured to direct coolant from the heat exchanger to the torch, and a control system. The control system is configured to determine a temperature of coolant flowing from the heat exchanger to the torch and output a signal based on the temperature of coolant flowing from the heat exchanger to the torch.

Other systems, methods, features and advantages will be, or will become, apparent to one with skill in the art upon examination of the following figures and detailed description. All such additional systems, methods, features and advantages are included within this description, are within the scope of the claimed subject matter.

### BRIEF DESCRIPTION OF THE DRAWINGS

The techniques presented herein may be better understood with reference to the following drawings and description. It should be understood that some elements in the figures may not necessarily be to scale and that emphasis has been placed upon illustrating the principles disclosed herein. In the figures, like-referenced numerals designate corresponding parts/steps throughout the different views.

FIG. 1A is a perspective view of an automated cutting system that may execute the techniques presented herein, according to an example embodiment of the present disclosure.

FIG. 1B is perspective view of an automated cutting head that may be included in the automated cutting system illustrated in FIG. 1A, according to an example embodiment of the present disclosure.

FIG. 1C is a schematic, cross-sectional view of an end portion of a plasma torch.

FIG. 2 illustrates a cross-sectional view of a consumable assembly utilized by the torch assembly illustrated in FIGS. 1A and 1B, according to an example embodiment of the present disclosure.

FIG. 3 illustrates a schematic diagram of a torch system with coolant sensing capabilities, according to an example embodiment of the present disclosure.

FIG. 4 illustrates a flowchart of a method for operating a torch system based on a temperature of coolant, according to an example embodiment of the present disclosure.

FIG. 5 illustrates a flowchart of a method for operating a torch system based on a level of coolant, according to an example embodiment of the present disclosure.

FIG. 6 illustrates a hardware block diagram of a computing device that may execute the techniques presented herein.

### DETAILED DESCRIPTION

The following description is not to be taken in a limiting sense but is given solely for the purpose of describing the broad principles of the present application. Embodiments of the present application will be described by way of example, with reference to the above-mentioned drawings showing elements and results of such embodiments.

The present disclosure is directed to determining a level of coolant circulating between a torch and a reservoir. The coolant is directed through the torch to reduce or limit a temperature increase of the torch. For example, the coolant may reduce wear of a component of the torch that otherwise may occur as a result of exposure of the component to an excessive temperature. As a result, structural integrity of the component may be maintained to increase a useful lifespan of the torch and/or to maintain a desirable operation of the torch provided by the component. The reservoir may be configured to receive coolant from the torch, store the coolant, and provide the coolant to the torch. For example, the reservoir may receive coolant that has absorbed heat from the torch for storage, and a temperature of the coolant stored in the reservoir may be reduced to place the coolant in condition for cooling the torch. The cooled coolant may then be directed from the reservoir to the torch to cool the torch.

However, in some circumstances, the level of coolant circulating between the torch and the reservoir may decrease. As an example, coolant may leak (e.g., from the torch, from the reservoir), may be discharged, or otherwise may exit from the flow path through the torch and the reservoir, and such coolant therefore may not be usable. As another example, there may be a blockage (e.g., in the torch, in piping connecting the reservoir and the torch to one another) hindering coolant from being directed between the torch and the reservoir. In either case, an amount of coolant available for cooling the torch may be reduced. Consequently, cooling of the torch via the coolant may also be reduced.

Determining a level of coolant in the reservoir may correspondingly determine an amount of coolant circulating between the reservoir and the torch to cool the torch. Embodiments of the present disclosure are directed to monitoring a temperature of coolant in the reservoir to determine the level of coolant in the reservoir. For instance, operation of the torch may output heat, which is absorbed by the coolant. As the level of coolant decreases, a reduced amount of coolant is available to absorb the heat output by the torch. That is, there is less distribution of the heat absorbed by the coolant because heat absorption is concentrated in the remaining amount of coolant. Thus, the heat output by the torch causes a greater temperature increase of the coolant. For this reason, an elevated temperature of coolant indicates a reduced level of coolant.

In some embodiments, such as embodiments in which operation of the torch system is at a steady state, the temperature of coolant is compared to a threshold temperature. In additional or alternative embodiments, such as embodiments in which operation of the torch system is at a transient state, a rate of temperature increase of coolant is compared to a threshold rate. The temperature exceeding the threshold temperature and/or the rate of temperature increase exceeding the threshold rate may indicate the level of coolant is undesirably low. To mitigate the low level of coolant, in some embodiments, operation of the torch may be suspended to avoid an excessive temperature increase of the torch caused by insufficient cooling. Additionally or alternatively, a notification may be provided to indicate the low level of coolant and prompt inspection and/or replenishment of the level of coolant. In either case, desirable operation and/or longevity of the torch may be maintained.

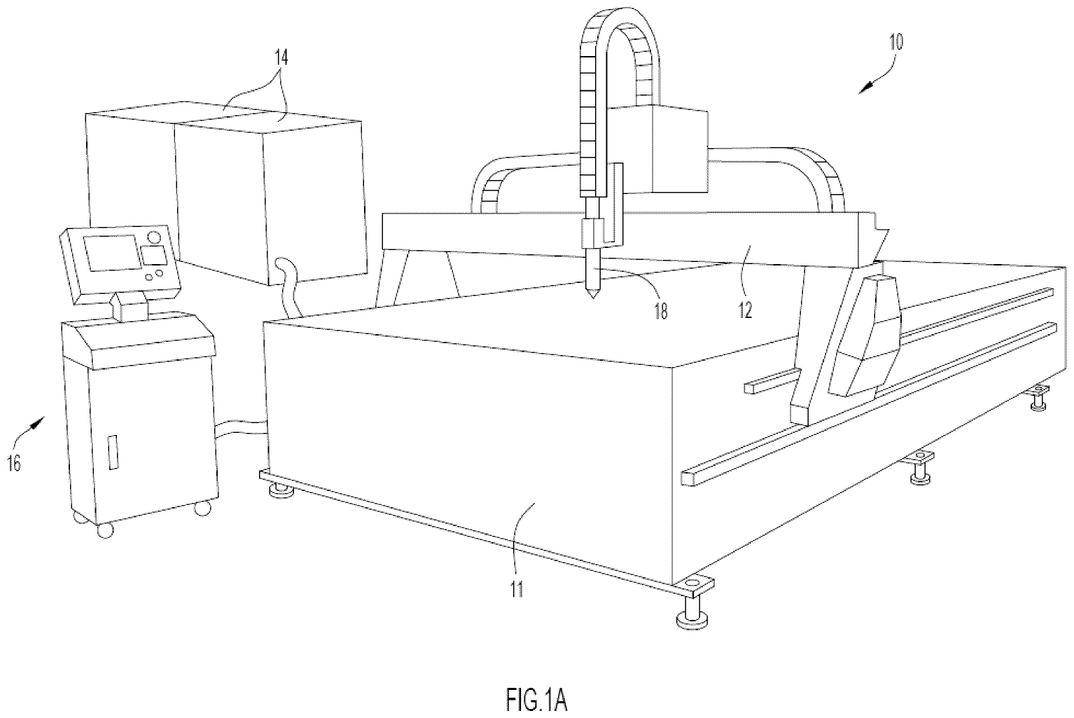

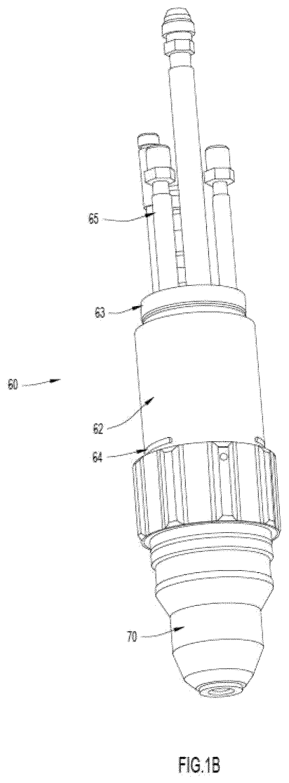

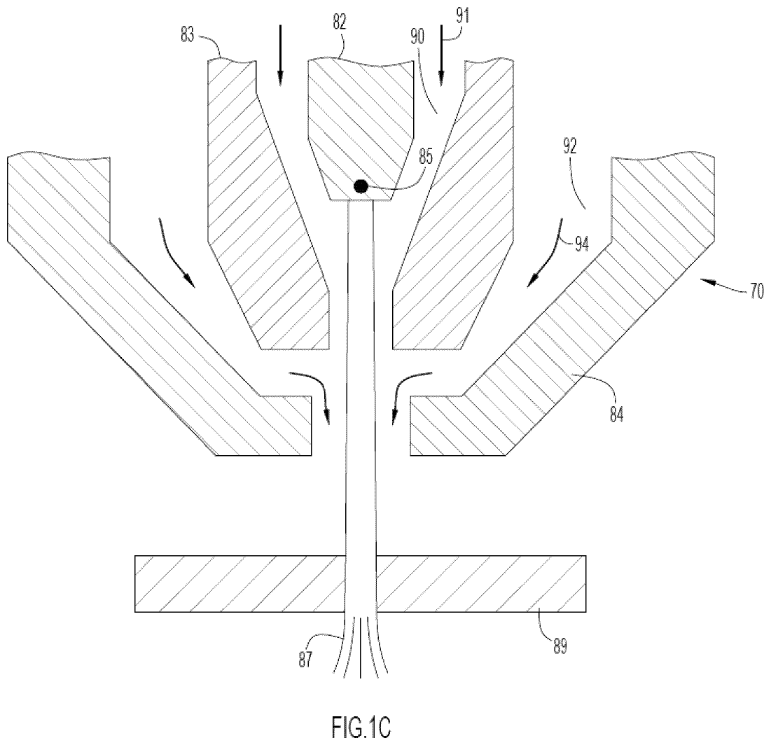

FIG. 1A illustrates an example embodiment of an automated cutting system 10 that may execute the techniques presented herein. However, this automated cutting system 10 is merely presented by way of example and the techniques presented herein may also be executed by manual cutting systems and/or automated cutting systems that differ from the automated cutting system 10 of FIG. 1A (e.g., any robotic or partially robotic cutting system). That is, the cutting system 10 illustrated in FIG. 1A is provided for illustrative purposes.

At a high-level, the cutting system 10 includes a table 11 configured to receive a workpiece (not shown), such as, but not limited to, sheets of metal. The automated cutting system 10 also includes a positioning system 12 that is mounted to the table 11 and configured to translate or move along the table 11. At least one automated plasma arc torch 18 is mounted to the positioning system 12 and, in some embodiments, multiple automated plasma arc torches 18 may be mounted to the positioning system 12. The positioning system 12 may be configured to move, translate, and/or rotate the torch 18 in any direction (e.g., to provide movement in all degrees of freedom).

Additionally, at least one power supply 14 is operatively connected to the automated plasma arc torch 18 and configured to supply (or at least control the supply of) electrical power and flows of one or more fluids to the automated plasma arc torch 18 for operation. Finally, a controller or control panel 16 is operatively coupled to and in communication with the automated plasma arc torch 18, the one or more power supplies 14, and the positioning system 12. The controller 16 may be configured to control the operations of the automated plasma arc torch 18, one or more power supplies 14, and/or the positioning system 12, either alone or in combination with the one or more power supplies 14.

In at least some embodiments, the one or more power supplies 14 meter one or more flows of fluid received from one or more fluid supplies before or as the one or more power supplies 14 supply gas to the torch 18 via one or more cable conduits. Additionally or alternatively, the automated cutting system 10 may include a separate fluid supply unit (not shown) or units that can provide one or more fluids to the automated torch 18 independent of the one or more power supplies 14. To be clear, as used herein, the term “fluid” shall be construed to include a gas or a liquid. The one or more power supplies 14 may also condition, meter, and supply power to the automated torch 18 via one or more cables, which may be integrated with, bundled with, or provided separately from cable conduits for fluid flows. Additional cables for data, signals, and the like may also interconnect the controller 16, the automated plasma arc torch 18, the power supply 14, and/or the positioning system 12. Any cable or cable conduit/hose included in the automated cutting system 10 may be any length. Moreover, each end of any cable or cable conduit/hose may be connected to components of the automated cutting system 10 via any connectors now known or developed hereafter (e.g., via releasable connectors).

FIG. 1B illustrates an example embodiment of an automated cutting head 60 that may be used with an automated cutting system executing the techniques presented herein (e.g., the cutting system 10 of FIG. 1A). As can be seen, the cutting head 60 includes a body 62 that extends from a first end 63 (e.g., a connection end 63) to a second end 64 (e.g., an operating or operative end 64). The connection end 63 of the body 62 may be coupled (in any manner now known or developed hereafter) to an automation support structure (e.g., a cutting table, robot, gantry, etc., such as positioning system 12). Meanwhile, conduits 65 extending from the connection end 63 of the body 62 may be coupled to like conduits in the automation support structure (e.g., positioning system 12) to connect the automated cutting head 60 to a power supply, one or more fluid supplies, a coolant supply, and/or any other components supporting automated cutting operations.

At the other end, the operative end 64 of the body 62 may receive interchangeable components, including consumable components 70 that facilitate cutting operations. For simplicity, FIGS. 1A and 1B do not illustrate connections portions of the body 62 that allow consumable components 70 to connect to the torch body 62 in detail. However, it should be understood that the cutting consumables, such as those schematically illustrated in FIG. 1C, may be coupled to a torch body 62 in any manner. Moreover, to be clear, the consumable stack/assembly 70 depicted in FIGS. 1B and 1C (with an external perspective view and a schematic cross-sectional illustration, respectively) is merely representative of a consumable stack that may be used with an automated torch executing the techniques presented herein. Similarly, while none of the Figures of the present application illustrate an interior of torch body 62, it is to be understood that any unillustrated components that are typically included in a torch, such as components that facilitate cutting operations, may (and, in fact, should) be included in a torch executing example embodiments of the present application.

Now turning to FIG. 1C, this Figure is a simplified/schematic illustration of the consumable stack 70 of FIG. 1B. As mentioned, FIG. 1C only illustrates select components or parts that allow for a clear and concise illustration of the techniques presented herein. Thus, in FIG. 1C, only an electrode 82, a nozzle 83, and a shield cap 84 of the consumable stack 70 are depicted. As can be seen, the electrode 82 is disposed at a center of the consumable stack 70 and includes an emitter 85 (e.g., formed from hafnium, tungsten, and/or other emissive materials) at a distal end portion thereof. The torch nozzle 83 is generally positioned around the electrode 82. In some embodiments, the nozzle 83 is installed after the electrode 82. Alternatively, the electrode 82 and nozzle 83 can be installed onto the torch body as a single component (e.g., these components may be coupled to each other to form a cartridge and installed on/in the torch body as a cartridge). In either case, the nozzle 83 may be spaced from the electrode 82; or, at least a distal portion of the nozzle 83 may be spaced apart from the distal portion of the electrode 82.

The shield 84 is positioned radially exteriorly of the nozzle 83 and is spaced apart from the nozzle 83, at least at its distal end. In some embodiments, the shield 84 is installed around an installation flange of the nozzle 83 in order to secure nozzle 83 and electrode 82 in place at (and in axial alignment with) an operating end of the torch body. Additionally or alternatively, the nozzle 83 and/or electrode 82 can be secured or affixed to a torch body in any desirable manner, such as by mating threaded sections included on the torch body with corresponding threads included on the components. For example, in some implementations, the electrode 82, nozzle 83, shield 84, as well as any other components (e.g., a lock ring, spacer, secondary cap, etc.) may be assembled together in a cartridge that may be selectively coupled to the torch body, e.g., by coupling the various components to a cartridge body or by coupling the various components to each other to form a cartridge.

In use, a plasma torch is configured to emit a plasma arc 87 between the electrode 82 and a workpiece 89 to which a work lead associated with a power supply is attached (not shown). As shown in FIG. 1C, the nozzle 83 is spaced a distance away from the electrode 82 so that a plasma gas flow channel 90 is disposed therebetween. During piercing and cutting operations, a plasma gas 91 flows through the plasma gas flow channel 90. The shield 84 is also spaced a distance away from the nozzle 83 so that a shield flow channel 92 is disposed between the shield 84 and the nozzle 83. A shield fluid 94 flows through the shield flow channel 92 during at least a portion of the time the torch is operated.

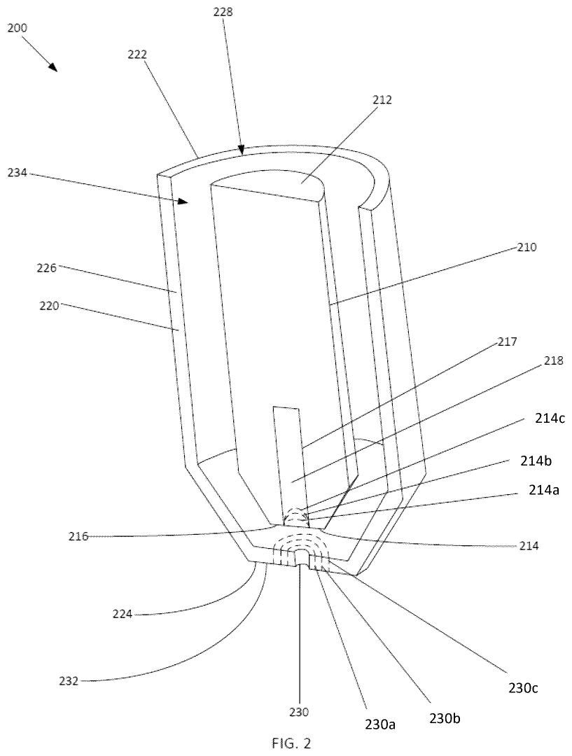

FIG. 2 illustrates a cross-sectional view of at least a portion of a consumable assembly 200. The consumable assembly 200 includes an electrode 210 and a nozzle 220. The electrode 210 is elongated with a first or proximal electrode end 212 and an opposite second or distal electrode end 214. The second electrode end 214 includes an end face 216 with a cavity 217, within which an emissive insert 218 may be disposed. The nozzle 220 includes a first or proximal nozzle end 222 and an opposite second or distal nozzle end 224. The nozzle 220 further includes a sidewall 226 that extends from the first nozzle end 222 to the second nozzle end 224. As illustrated, a first opening 228 is disposed within the first nozzle end 222 of the nozzle 220, while a second nozzle opening or orifice 230 is disposed within an end face 232 of the second nozzle end 224 of the nozzle 220. The first nozzle end 222, the second nozzle end 224, and the sidewall 226 may collectively define an interior volume or interior cavity 234. As illustrated in FIG. 2, the electrode 210 is at least partially disposed within the interior cavity 234 such that the emissive insert 218 is disposed proximate to, and axially aligned with, the nozzle opening 230 of the nozzle 220.

The consumable assembly 200 is configured to couple to a torch body to enable a torch to direct gas to the consumable assembly 200 during operation of the torch system. For example, the torch body is configured to discharge the gas into the interior cavity 234 and toward the second nozzle opening 230. At least for plasma cutting, discharge of the gas through the second nozzle opening 230 facilitates formation of an arc between the consumable assembly 200 and a metal workpiece to perform the processing operation on the metal workpiece.

Different types or embodiments of the consumable assembly 200 may be implemented in the torch system. That is, the torch body may be configured to couple to different types of consumable assemblies 200 to perform different processing operations, such as different types of cutting or welding operations based on a desired modification of the metal workpiece. In some embodiments, different types of consumable assemblies 200 may have dissimilar features, such as differently sized and/or shaped end faces 216, emissive inserts 218, and/or second nozzle openings 230. A series of different second electrode end profiles 214a, 214b, 214c of the end face 216 of the electrode 210 are shown in phantom lines. The second electrode end profiles 214a, 214b, 214c represent other possible configurations (e.g., contours) of the end face 216 of the electrode 210 for different types of the consumable assembly 200. Additionally, a series of different second nozzle opening profiles 230a, 230b, 230c of the nozzle 220 are shown in phantom lines. The second nozzle opening profiles 230a, 230b, 230c represent other possible configurations (e.g., opening sizes) of the second nozzle opening 230. These nozzle and electrode profiles might also be representative of wear.

However, to be clear, the profiles illustrated in FIG. 2 illustrate example geometric configurations, and different types of consumable assemblies 200 may include additional or alternative physical features that are different from one another. For example, different embodiments may include various surface formations (e.g., bumps, etchings, knurls), different electrode dimensions (e.g., widths, lengths), different sizes of the interior cavity 234, and so forth. Moreover, different consumable assemblies may include different consumables, either in addition to or instead of the consumables generally illustrated in FIG. 2. For example, welding consumables might comprise a contact tip and distributor, plasma consumables might comprise a shield, shield cap, distributor, spring, etc., and these various consumables may create any desirable gas paths—e.g., flowing in any direction, through any desirable holes, cuts, ridges, etc. Still further, some consumable assemblies 200 might have more than one gas path that are isolated from one or more other gas paths, and any of these gas paths might be utilized to execute the techniques presented herein.

Regardless of the consumable properties, coolant may be directed through the consumable assembly 200 and other components to cool the torch. For example, the coolant may be circulated between the torch and a reservoir (e.g., a storage tank). A temperature of coolant in the reservoir is indicative of the level of coolant in the reservoir and therefore circulating between the torch and the reservoir. For this reason, the temperature of coolant in the reservoir is monitored to determine whether the level of coolant is desirable.

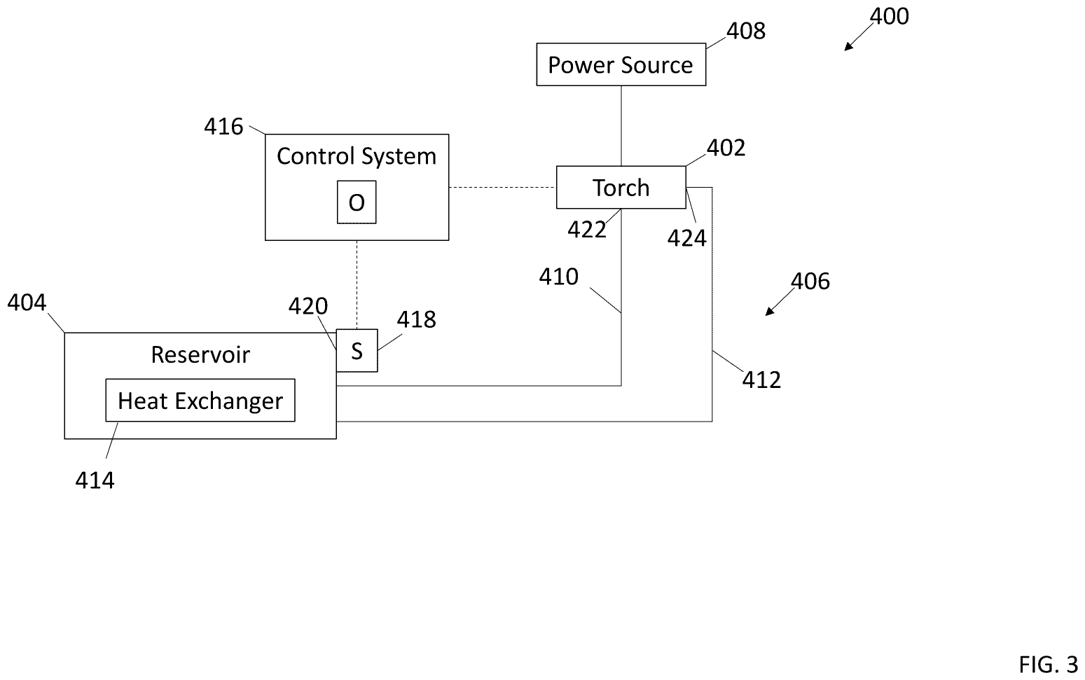

FIG. 3 is a schematic diagram of a torch system 400 that includes a torch 402 and a reservoir 404, as well as a conduit system 406 fluidly coupling the torch 402 and the reservoir 404 to one another. During operation of the torch system 400, a power source 408 provides power to the torch 402 to cause the torch 402 to perform a welding and/or a cutting operation (e.g., by generating an arc), and the conduit system 406 circulates coolant between the torch 402 and the reservoir 404. For example, a first conduit 410 (e.g., a supply channel) of the conduit system 406 may direct coolant from the reservoir 404 to the torch 402 to enable the coolant to absorb heat from the torch 402, thereby cooling the torch 402 and heating the coolant. A second conduit 412 (e.g., a return channel) of the conduit system 406 may direct coolant (e.g., heated coolant) from the torch 402 to the reservoir 404. The reservoir 404 then stores the coolant, and the coolant may be cooled within the coolant to increase the cooling capability of the coolant. For example, the reservoir 404 may include or be thermally coupled to a heat exchanger 414 (e.g., a cooling coil, a vapor compression system) configured to receive coolant from the second conduit 412 and cool the coolant. The cooled coolant may then be directed from the heat exchanger 414 to the torch 402 via the first conduit 410 to provide additional cooling of the torch 402.

Operation of the torch 402 causes the torch 402 to output heat, and the coolant directed through the torch 402 absorbs the heat. For a threshold duration of time within initiating operation of the torch system 400, the torch system 400 may be in a transient state during which the heat output by the torch 402 may substantially fluctuate and/or a temperature of the coolant (e.g., coolant circulating between the reservoir 404 and the torch 402) has yet to reach an expected temperature. For this reason, a temperature of coolant in the reservoir 404 may also substantially fluctuate during the transient state. After the threshold duration of time has elapsed, the torch system 400 may be in a steady state during which the heat output by the torch 402 may be stable and/or the coolant has reached the expected temperature. As such, the temperature of coolant in the reservoir 404 may also be stable during the steady state.

The torch system 400 also includes a control system 416 (e.g., a programmable controller, an electronic controller, an automation controller, a computing device, control circuitry) configured to monitor a temperature of coolant in the reservoir 404. In certain embodiments, the control system 416 is communicatively coupled to a sensor 418 configured to monitor a temperature of coolant in the reservoir 404. For instance, the sensor 418 may be positioned exterior of the reservoir 404 to avoid contacting the coolant and/or avoid reducing a storing capacity within the reservoir 404. However, the sensor 418 is arranged such that readings made by the sensor 418 accurately indicate the actual temperature of coolant. As an example, the sensor 418 is configured to determine the temperature of coolant through the reservoir 404, such as based on capacitance of a wall 420 (e.g. a metal wall) of the reservoir 404. In such implementations, there may be relatively limited factors, such as structural material, that would cause the sensor 418 to determine an inaccurate temperature reading through the reservoir 404, such as in comparison to determining temperature within the torch 402. In other words, the sensor 418 may determine the temperature of the coolant more accurate in the illustrated arrangement than in an arrangement in which the sensor 418 is positioned adjacent to the torch 402. Moreover, coolant may have relatively more steady and consistent temperature at different locations in the reservoir 404, such as in comparison to coolant at different locations in the torch 402, which may have a temperature differential between different parts that can correspondingly cause fluctuations of temperature of coolant adjacent to and/or in contact with the different parts. Further still, the sensor 418 may be more easily positioned at the reservoir 404 than at the torch 402, where there may be less available space for accommodating the sensor 418, where the sensor 418 may not be as easily accessible (e.g., for inspection, replacement, repair), and/or where the sensor 418 may affect an operation of the torch 402.

As an example, the sensor 418 is configured to monitor a temperature of a coolant flow cooled by the heat exchanger 414 prior to discharge from the reservoir 404 toward the torch 402 via the first conduit 410. As another example, the sensor 418 is configured to monitor a temperature of a coolant flow prior to the coolant flow being cooled by the heat exchanger 414, such as a coolant flow received from the torch 402 via the second conduit 412. As a further example, the sensor is configured to monitor a temperature of a coolant flow being cooled by the heat exchanger 414. Further still, in certain embodiments, the sensor 418 is configured to monitor a temperature of coolant flowing exterior, but adjacent, to the reservoir 404, such as through the conduit system 406.

In any case, the control system 416 is configured to receive data indicative of coolant temperature from the sensor 418 and perform a corresponding operation based on the data. For example, temperature of coolant in the reservoir 404 may indicate a level of coolant in the reservoir 404 and/or circulating between the reservoir 404 and the torch 402. In some embodiments, the control system 416 may compare the temperature indicated by the data to a threshold temperature. By way of example, because the temperature of coolant in the reservoir 404 is expected to be stable during the steady state of the torch system 400, a temperature increase of coolant during the steady state may indicate a reduced level of coolant in the reservoir 404 and circulating between the reservoir 404 and the torch 402. In particular, a change in temperature of coolant is based on the equation:

$$q = m ⋆ C ⋆ T \qquad ( Equation 1 )$$

in which q is heat output into coolant, m is mass of coolant, C is heat capacity (i.e., the amount of heat energy to increase temperature) of coolant, and T is the change in temperature of coolant. As mentioned, the heat output by the torch 402 may be stable at steady state. Additionally, heat capacity of the coolant remains constant. Therefore, an increase in temperature change, as indicated by a temperature of coolant exceeding the threshold temperature, indicates a decrease in mass and level of coolant, because there is less coolant available to absorb the heat being output by the torch 402. In other words, the temperature of coolant exceeding the threshold temperature may indicate a relatively low level of coolant.

In certain embodiments, the amount of heat (i.e., the variable q of Equation 1) is calculated to determine the threshold temperature. For example, heat is based on the equation:

$$q = Q ⋆ t \qquad ( Equation 2 )$$

in which q is heat output into coolant, Q is power input into the torch system 400, and t is time. Therefore, power provided to the torch system 400 (e.g., based on an input rating of the power source 408, based on power measurements at different locations of the torch system 400, such as at the torch 402) is determined for a duration of time to calculate heat. The expected change in temperature, which may indicate an expected threshold temperature, for a mass of coolant (e.g., indicative of a target, desirable, or sufficient level of coolant) is then determined based on the power provided for the duration of time. By determining the threshold temperature based on power, a more suitable or representative threshold temperature may be more accurately, such as in comparison to using a constant threshold temperature regardless of changes in power input to the torch system 400.

The threshold temperature may also be selected based on operation of the torch 402, such as based on a portion or segment of an operation (e.g., piloting, ramp-up, piercing, cutting, ramp-down), an operating mode, or another parameter of a welding or cutting operation currently being executed by the torch 402. Indeed, different operations of the torch 402 may change the heat output by the torch 402 and therefore change the expected temperature increase of coolant. As such, selecting the particular threshold temperature to which the temperature of coolant is compared may enable the level of coolant, such as a low level of coolant expected to be used in a specific operation of the torch 402, to be determined more accurately.

Additionally or alternatively, the control system 416 may compare a temperature increase of coolant to a threshold rate. For instance, during the transient state, the temperature of coolant may increase toward the threshold temperature. However, a greater rate in temperature increase of coolant may indicate a relatively low level of coolant. For example, using Equation 1, an amount of heat may be output by the torch 402 over a particular period of time to cause the temperature of a constant mass of coolant to increase by a particular amount over the particular period of time. An excessive increase in temperature over the particular period of time may indicate a decrease in mass and level of coolant. Thus, the rate of temperature increase exceeding the threshold rate may also indicate a relatively low level of coolant. By way of example, the temperature of coolant reaching a threshold temperature before a threshold duration of time since initiating operation of the torch system 400 has elapsed may indicate that the level of coolant is low (e.g., below a threshold level that would cause the temperature of coolant to reach the threshold temperature at or after the threshold duration of time since initiating operation of the torch system 400 has elapsed), because a lower level of coolant absorbs heat output by the torch 402 at a higher rate. In some embodiments, the threshold rate may be determined using Equation 1 and/or Equation 2 by determining the power provided to the torch system 400 (e.g., over a particular period of time).

In yet another embodiment, the temperature of coolant in the reservoir 404 may be compared to a temperature of the torch 402 (e.g., a temperature of coolant in the torch 402, a temperature of a torch component cooled by the coolant), and a temperature difference between the temperature of coolant in the reservoir 404 and the temperature of the torch 402 is determined. For example, a temperature difference being above a threshold temperature may indicate there being a blockage in the torch 402 and/or in the conduit system 406 (e.g., in the first conduit 410, in the second conduit 412) that reduces discharge of coolant from the torch 402, such that there is a low level of coolant actively circulating between the reservoir 404 and the torch 402. That is, a coolant flow may remain in the torch 402 for an excessive amount of time to cause the coolant flow to absorb an excessive amount of heat that elevates the temperature of the coolant flow in the torch 402. The elevated temperature of the torch 402 relative to the temperature of coolant in the reservoir 404 may indicate the existence of a blockage causing a low level of coolant circulating between the reservoir 404 and the torch 402.

Further still, in certain embodiments, the control system 416 is configured to determine the level of coolant based on the temperature. That is, the control system uses the temperature to derive or calculate the level of coolant in the reservoir 404 and/or circulating between the torch 402 and the reservoir 404. For instance, the control system 416 may set Equation 1 equal to Equation 2, determine the power provided to the torch system 400 and the change in temperature of coolant, and then subsequently calculate the mass of coolant. In such embodiments, the control system 416 may compare the level of coolant (e.g., mass) to a threshold level (e.g., a threshold mass) and/or compare a rate of decrease of the level of coolant to a threshold rate to determine whether the level of coolant is low.

The control system 416 is configured to perform a corresponding operation based on the data received from the sensor 418. For instance, in response to determining the data indicates a sufficient level of coolant (e.g., the temperature of coolant in the reservoir 404 is at or below the threshold temperature, the rate of temperature increase of coolant in the reservoir 404 is at or below the threshold rate, the level of coolant is at or above the threshold level, the rate of decrease of the level of coolant is at or below the threshold rate, a temperature difference between the temperature of coolant in the reservoir 404 and the temperature of the torch 402 is at or below a threshold temperature), the control system 416 may not adjust operation of the torch system 400. Thus, the torch 402 continues to operate, and coolant continues to circulate between the reservoir 404 and the torch 402. However, in response to determining the data indicates a low level of coolant (e.g., the temperature of coolant in the reservoir 404 is above the threshold temperature, the rate of temperature increase of coolant in the reservoir 404 is above the threshold rate, the level of coolant is below the threshold level, the rate of decrease of the level of coolant is above the threshold rate, the temperature difference between the temperature of coolant in the reservoir 404 and the temperature of the torch 402 is above the threshold temperature), the control system 416 may output a signal. As an example, a low level of coolant may indicate a leakage or other cause of coolant to exit the flow path through the torch system 400. As another example, a low level of coolant may indicate a potential blockage that impedes flow of coolant through a portion of the torch system 400, such as at an inlet 422 to the torch 402 and/or at an outlet 424 out of the torch 402. In either case, continued operation of the torch system 400 with the low level of coolant may be undesirable, because such operation would elevate the temperature of the torch 402, which may affect a structural integrity and/or efficiency of the torch 402. For this reason, the signal is output to adjust operation of the torch system 400, such as to suspend operation of the torch system 400, thereby avoiding operation of the torch 402 while the level of coolant circulating between the reservoir 404 and the torch 402 is low. Thus, potential insufficient cooling of the torch 402 during operation may be avoided to improve a structural integrity and/or a useful lifespan of the torch 402.

In additional or alternative embodiments, the signal output by the control system 416 provides a notification. By way of example, the control system 416 may include an output device 426 (e.g., a light emitter, such as a display, an audio emitter, such as a speaker, an electrical connector, such as a cable), which may cause the notification to be provided. For instance, the signal may cause the control system 416 to provide a visual display, output a sound, and/or transmit the notification to another device (e.g., a user device). Thus, the notification may be observed by a user, such as a technician and/or an operator, to prompt the user to address the low level of coolant. For example, the notification may inform the user to inspect/address a blockage of the flow path of coolant and/or to inspect/replenish the level of coolant, thereby enabling the torch system 400 to operate with a sufficient flow rate of coolant circulating between the reservoir 404 and the torch 402.

It should be noted that the sensor 418 may replace another type of sensor, such as a level sensor, used to monitor the level of coolant. Thus, the torch system 400 may not include the other type of sensor. For example, the other type of sensor may provide undesirable effects, such as increasing manufacturing/operational costs and/or interfering with other operation of the torch system, upon implementation. Indeed, as compared to another parameter of coolant, temperature of coolant in the reservoir may be more readily and suitably monitored for effectuating operation based on the level of coolant. However, in alternative embodiments, the torch system 400 may include another type of sensor used to monitor the level of coolant, and the sensor 418 may supplement measurements provided by the other type of sensor.

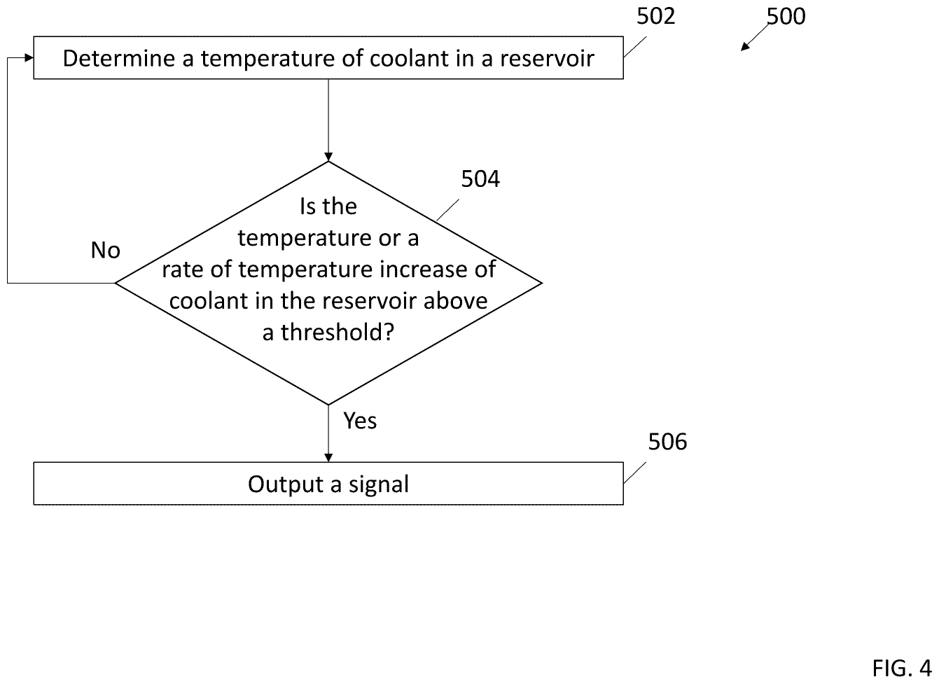

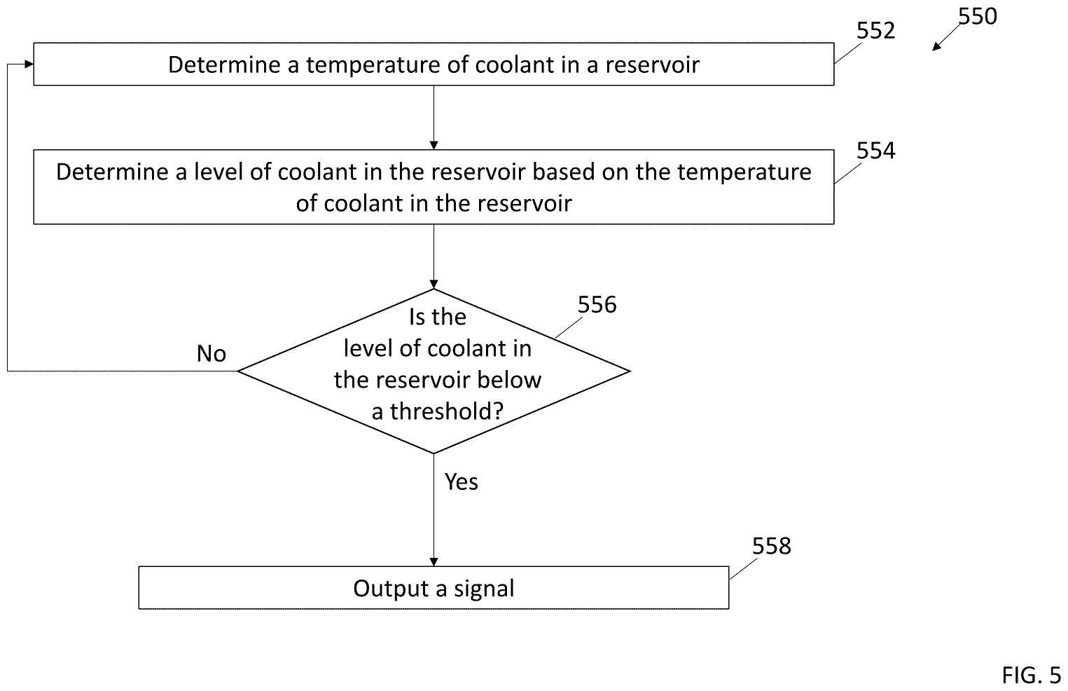

Each of FIGS. 4 and 5 discussed below illustrates a respective method for operating a torch system, such as the torch system 400. In some embodiments, the operations of each method are performed by a single entity (e.g., the control system 416). In additional or alternative embodiments, the operations of each method are performed by separate entities. It should be noted that the operations of the method may be performed differently than depicted. For example, an additional operation may be performed, and/or any of the depicted operations may be performed differently, performed in a different order, and/or not performed. Furthermore, the operations of the respective methods may be performed in any suitable manner relative to one another, such as sequentially and/or concurrently.

FIG. 4 is a flowchart of a method 500 for operating a torch system based on a temperature of coolant in a reservoir of the torch system. At block 502, the temperature of coolant in the reservoir is determined. For example, a sensor positioned at the reservoir may be determined to monitor the temperature of coolant, and data indicative of the temperature may be received from the sensor. In some embodiments, the temperature is of a coolant flow after the coolant flow has been cooled by a heat exchanger (e.g., coolant flow directed from the heat exchanger toward a torch of the torch system and prior to the coolant flow reaching the torch). In additional or alternative embodiments, the temperature is of a coolant flow before the coolant flow has been cooled by the heat exchanger (e.g., upon receipt of the coolant flow from the torch). In further embodiments, the temperature is of a coolant flow within and cooled by the heat exchanger.

At block 504, the temperature of coolant in the reservoir is used for comparison. In certain embodiments, the temperature of coolant in the reservoir is compared to a threshold temperature. In additional or alternative embodiments, a rate of temperature increase of coolant in the reservoir is compared to a threshold rate. To this end, a temperature of coolant over a period of time is determined. In any case, the threshold temperature and/or the threshold rate may be determined based on power provided to the torch system and a target or desirable level of coolant by performing calculations provided in Equation 1 and/or Equation 2. Additionally or alternatively, the threshold temperature and/or the threshold rate may be selected based on operation of the torch, such as a portion of a cutting operation and/or of a welding operation currently being executed.

In response to a determination that the temperature of coolant is not above the threshold temperature and/or a rate of temperature increase of coolant is not above the threshold rate, no changes in operation of the torch system are performed. Instead, the temperature of coolant in the reservoir may continue to be determined in accordance with block 502. However, at block 506, in response to a determination that the temperature of coolant is above the threshold temperature and/or the rate of temperature increase of coolant is above the threshold rate, which indicates a potential low level of coolant circulating between the reservoir and the torch, a signal is output. For instance, the signal is output to suspend operation of the torch system, thereby preventing or reducing operation of the torch system while the level of coolant is low. Additionally or alternatively, the signal is output to provide a notification, such as a visual output, an audio output, and/or a notification transmitted to a user device. In such embodiments, the notification may prompt a user to address the low level of coolant, such as to replenish the coolant and/or to address a potential blockage hindering flow of the coolant.

In certain embodiments, the temperature of coolant is compared to the temperature of another component, such as the torch, of the torch system to a determine a temperature difference. The temperature difference is then compared to a threshold temperature. By way of example, the temperature difference exceeding a threshold temperature may indicate that a low level of coolant is circulating to absorb a sufficient amount of heat from the torch (e.g., due to a blockage within the torch). For this reason, the signal is output in response to determining the temperature difference is above the threshold temperature.

FIG. 5 is a flowchart of a method 550 for operating a torch system based on a level of coolant in a reservoir of the torch system. At block 552, the temperature of coolant in the reservoir is determined, such as based on data received from a sensor. At block 554, the level of coolant is determined based on the temperature of coolant in the reservoir. As an example, an equation may be used to calculate the level of coolant based on the temperature of coolant. As another example, a lookup table may be referenced to determine the level of coolant corresponding to the temperature of coolant. In either case, the level of coolant is derived from the temperature of coolant and power provided to the torch system (e.g., according to operation of the torch and/or a power rating of a power source), such as by using Equation 1 and/or Equation 2, and used for comparison.

At block 556, the level of coolant is compared to a threshold level to determine whether the level of coolant is relatively low. In additional or alternative embodiments, a rate of decrease of the level of coolant is compared to a threshold rate. In such embodiments, a determination is made regarding whether the level of coolant is decreasing at an undesirable rate.

In response to a determination that the level of coolant is above the threshold level, thereby indicating the level of coolant is not relatively low, no changes in operation of the torch system are performed. Similarly, in response to a determination that the rate of decrease of the level of coolant is not above the threshold rate, thereby indicating the level of coolant is not decreasing at an undesirable rate, no changes in operation of the torch system are performed. In response, the temperature of coolant in the reservoir continues to be determined in accordance with block 552.

However, at block 558, in response to a determination that the level of coolant is below the threshold level and/or a determination that the rate of decrease of the level of coolant is not below the threshold rate, a signal is output. The signal suspends operation of the torch system and/or provides a notification to prompt a user to address the level of coolant circulating between the reservoir and the torch.

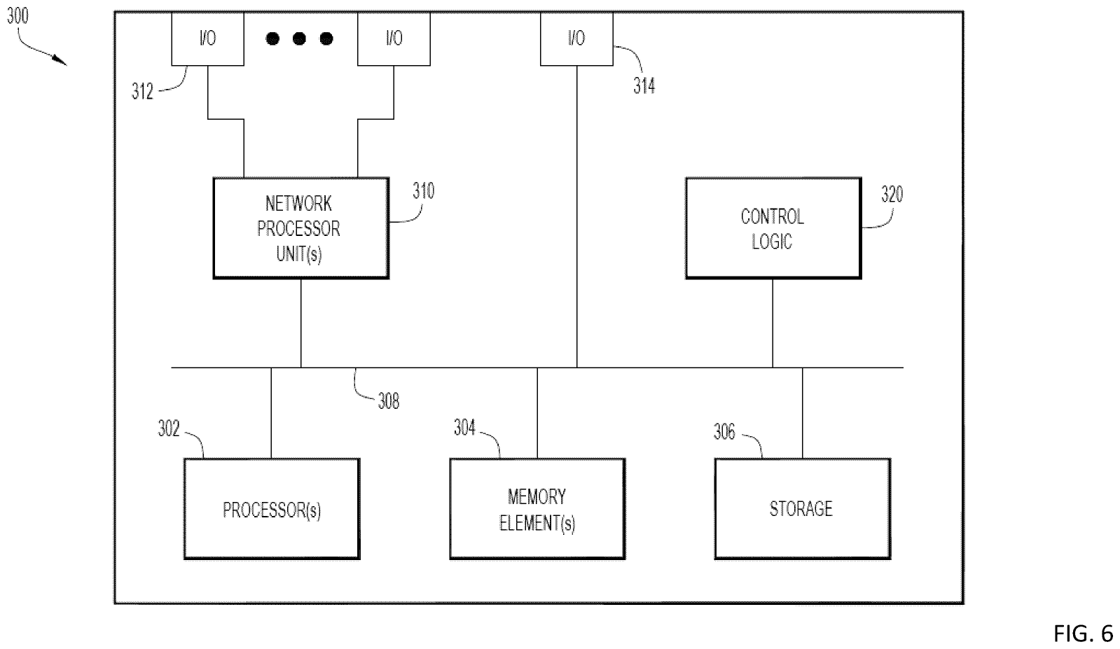

FIG. 6 illustrates a hardware block diagram of a computing device 300 that may execute the techniques presented herein. This computing device 300 may be included in or formed from portions of any combination of parts included in the controller 16, the automated plasma arc torch 18, the power supply 14, and/or the positioning system 12 of an automated cutting system 10, as well as the control system 416 of the torch system 400. Thus, any of the controller 16, the automated plasma arc torch 18, the power supply 14, the positioning system 12, and/or the control system 416 may execute the techniques presented herein, alone or in combination with one or more other systems/components.

As depicted, the computing device 300 includes a bus 308, which provides communications between processor(s) 302, one or more memory elements 304, persistent storage or memory 306, one or more network processor units 310 (i.e., a communications unit), and input/output (I/O) interface(s) 314. The bus 308 can be implemented with any architecture designed for passing data and/or control information between processors (such as microprocessors, communications and network processors, etc.), system memory, peripheral devices, and any other hardware components within a system. For example, the bus 308 can be implemented with one or more buses.

The memory 306 and/or memory element 304 may include random access memory (RAM) or other dynamic storage devices (i.e., dynamic RAM (DRAM), static RAM (SRAM), and synchronous DRAM (SD RAM)), for storing information and instructions to be executed by the processor 302. The memory 306 and/or memory element 304 may also include a read only memory (ROM) or other static storage device (i.e., programmable ROM (PROM), erasable PROM (EPROM), and electrically erasable PROM (EEPROM)) for storing static information and instructions for the processor 302. Additionally, although “control logic” 320 is illustrated separately from the memory 306 and/or memory element 304, the control logic 320 may be stored as non-transitory computer-readable instructions in the memory 306 and/or memory element 304, for execution by the processor 302 so that the processor 302 can execute the techniques presented herein.

Although FIG. 6 shows the processor 302 as a single box, it should be understood that the processor 302 may represent a plurality of processing cores, each of which can perform separate processing. The processor 302 may also include special purpose logic devices (i.e., application specific integrated circuits (ASICs)) or configurable logic devices (i.e., simple programmable logic devices (SPLDs), complex programmable logic devices (CPLDs), and field programmable gate arrays (FPGAs)), that, in addition to microprocessors and digital signal processors may individually, or collectively, are types of processing circuitry.

The processor 302 performs a portion or all of the processing steps required to execute the techniques presented herein, e.g., in response to instructions received at the network processor unit(s) 310 and/or instructions contained in the memory 304 and/or memory 306. Such instructions may be read into the memory 304 and/or memory 306 from another computer-readable medium. One or more processors in a multi-processing arrangement may also be employed to execute the sequences of instructions contained in the memory 304 and/or memory 306. In alternative embodiments, hard-wired circuitry may be used in place of or in combination with software instructions. Thus, embodiments are not limited to any specific combination of hardware circuitry and software. Put another way, the computing device 300 includes at least one computer-readable medium or memory for holding instructions programmed according to the embodiments presented, for containing data structures, tables, records, or other data described that might be required to execute the techniques presented herein.

Still referring to FIG. 6, the network processor unit(s) 310 provides a two-way data communication coupling to a network, such as a local area network (LAN) or the Internet. The two-way data communication coupling provided by the network processor unit(s) 310 can be wired (e.g., via I/O interface(s) 312) or wireless. Meanwhile, I/O interface(s) 314 may allow for input and output of data with other devices that may be connected to the computing device 300. For example, the I/O interface 314 may provide a connection to external devices such as a keyboard, keypad, a touch screen, and/or some other suitable input device. External devices can also include portable computer-readable storage media such as database systems, thumb drives, portable optical or magnetic disks, and memory cards.

While the apparatuses and methods presented herein have been illustrated and described in detail and with reference to specific embodiments thereof, it is nevertheless not intended to be limited to the details shown, since it will be apparent that various modifications and structural changes may be made therein without departing from the scope of the disclosure and within the scope and range of equivalents of the claims. For example, the torch system 400 may have any other suitable components. Additionally, the methods presented herein may be suitable for any type of welding and/or cutting consumable assemblies, including consumable assemblies utilized for automated (e.g., mechanized) and/or manual (e.g., handheld) operations.

In addition, various features from one of the embodiments may be incorporated into another of the embodiments. That is, it is believed that the disclosure set forth above encompasses multiple distinct embodiments with independent utility. While each of these embodiments has been disclosed in a preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure. Additionally, it is also to be understood that the components of the apparatuses described herein, the consumable assemblies described herein, or portions thereof may be fabricated from any suitable material or combination of materials, such as plastic or metals (e.g., copper, bronze, hafnium, etc.), as well as derivatives thereof, and combinations thereof. In addition, it is further to be understood that the steps of the methods described herein may be performed in any order or in any suitable manner.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about”, “around”, “generally”, and “substantially.”

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the description herein. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

What is claimed is:

1. A torch system, comprising:
a torch configured to perform a welding or cutting operation;
a reservoir configured to store coolant;
a conduit system configured to circulate coolant between the reservoir and the torch to cool the torch; and
a control system configured to:
determine a temperature of coolant in the reservoir, wherein the temperature of coolant in the reservoir indicates a level of coolant circulating between the reservoir and the torch;
compare the temperature of coolant in the reservoir to a threshold temperature; and
output a signal in response to determining the temperature of coolant in the reservoir exceeds the threshold temperature.

2. The torch system of claim 1, further comprising:
a heat exchanger configured to reduce the temperature of coolant in the reservoir, wherein the conduit system is configured to direct coolant cooled by the heat exchanger to the torch.

3. The torch system of claim 2, further comprising a temperature sensor configured to determine a temperature of coolant flowing from the heat exchanger to the torch and/or a temperature of coolant prior to cooling by the heat exchanger, wherein the control system is configured to determine the temperature of coolant in the reservoir based on data received from the temperature sensor.

4. The torch system of claim 1, wherein the control system is configured to output the signal to suspend operation of the torch.

5. The torch system of claim 1, wherein the control system is configured to output the signal to provide a notification.

6. The torch system of claim 1, wherein the control system is configured to select the threshold temperature for comparison with the temperature of coolant in the reservoir based on the welding or cutting operation currently being executed.

7. The torch system of claim 1, wherein the reservoir does not include a level sensor configured to determine a level of coolant in the reservoir.

8. The torch system of claim 1, wherein the control system is further configured to:
determine an amount of power provided to the torch system;
determine a target level of coolant circulating between the reservoir and the torch; and
determine the threshold temperature based on the amount of power provided to the torch system and the target level of coolant circulating between the reservoir and the torch.

9. The torch system of claim 8, wherein the control system is configured to determine the amount of power provided to the torch system based on an input rating of a power source configured to provide power to the torch.

10. The torch system of claim 1, wherein the control system is configured to:
determine a rate of temperature increase of coolant in the reservoir based on the temperature of coolant in the reservoir;
compare the rate of temperature increase to a threshold rate; and
output the signal in response to determining the rate of temperature increase exceeds the threshold rate.

11. A non-transitory computer-readable medium comprising instructions that, when executed by one or more processors, are configured to cause the one or more processors to:
determine a temperature of coolant in a reservoir, wherein the reservoir stores coolant circulating through a torch configured to perform welding or cutting operation;
determine a level of coolant circulating between the reservoir and the torch based on the temperature of coolant in the reservoir; and
output a signal based on the level of coolant in the reservoir.

12. The non-transitory computer-readable medium of claim 11, wherein the instructions, when executed by the one or more processors, are configured to cause the one or more processors to:
determine an amount of heat output by the torch; and
determine the level of coolant circulating between the reservoir and the torch based on the temperature of coolant in the reservoir and the amount of heat output by the torch.

13. The non-transitory computer-readable medium of claim 11, wherein the instructions, when executed by the one or more processors, are configured to cause the one or more processors to output the signal in response to determining the level of coolant circulating between the reservoir and the torch is below a threshold level.

14. The non-transitory computer-readable medium of claim 11, wherein the instructions, when executed by the one or more processors, are configured to cause the one or more processors to:
determine a rate of decrease of the level of coolant circulating between the reservoir and the torch based on the temperature of coolant in the reservoir; and
output the signal based on the rate of decrease of the level of coolant circulating between the reservoir and the torch.

15. The non-transitory computer-readable medium of claim 14, wherein the instructions, when executed by the one or more processors, are configured to cause the one or more processors to output the signal in response to determining the rate of decrease of the level of coolant circulating between the reservoir and the torch exceeds a threshold rate.

16. A torch system, comprising:
a torch configured to perform a welding or cutting operation;
a reservoir configured to store coolant;
a heat exchanger configured to reduce a temperature of coolant in the reservoir;
a conduit system configured to direct coolant from the heat exchanger to the torch; and
a control system configured to perform operations comprising:
determining a temperature of coolant flowing from the heat exchanger to the torch; and
outputting a signal based on the temperature of coolant flowing from the heat exchanger to the torch.

17. The torch system of claim 16, wherein the control system is configured to output the signal based on the temperature of coolant flowing from the heat exchanger to the torch by:
comparing a rate of temperature increase of coolant flowing from the heat exchanger to the torch to a threshold rate; and
outputting the signal in response to determining the rate of temperature increase of coolant flowing from the heat exchanger to the torch is above the threshold rate.

18. The torch system of claim 16, wherein the control system is configured to perform operations comprising:
determining a temperature of the torch;
determining a temperature difference between the temperature of coolant flowing from the heat exchanger to the torch and the temperature of the torch is above a threshold temperature; and
outputting the signal in response to determining the temperature difference between the temperature of coolant flowing from the heat exchanger to the torch and the temperature of the torch is above the threshold temperature.

19. The torch system of claim 16, comprising a sensor configured to provide data to the control system to indicate the temperature of coolant flowing from the heat exchanger to the torch.

20. The torch system of claim 19, wherein the sensor is disposed external to the reservoir.
